(19) United States
(12) Patent Application Publication
(10) Pub. No.: US 2023/0125160 A1
(43) Pub. Date: Apr. 27, 2023

(54) Sidelink Positioning Architecture for Wireless Communications

(71) Applicant: Apple Inc., Cupertino, CA (US)

(72) Inventors: Alexander Sirotkin, Herzliya (IL); Sudeep Manithara Vamanan, Nuremberg (DE); Zhibin Wu, Los Altos, CA (US)

(21) Appl. No.: 17/970,349

(22) Filed: Oct. 20, 2022

Related U.S. Application Data
(60) Provisional application No. 63/270,460, filed on Oct. 21, 2021.

(51) Int. Cl. H04W 64/00

(52) U.S. Cl. CPC H04W 64/00

(57) ABSTRACT

Sidelink positioning for wireless communications may be achieved by extending the current LCS (LoCation Services) architecture, ProSe (PROximity based SErvices) architecture, and V2X (Vehicle-to-Everything) architecture to include sidelink positioning, e.g., during New Radio (NR) wireless communications. The existing architecture infrastructures of LCS, ProSe and V2X may be expanded to include additional signaling and/or they may be modified to incorporate communication of sidelink positioning information into existing signaling, and/or modify existing signaling to carry instructions between user equipment devices (UEs) as well as between UEs and relevant network functions either directly or via base stations when applicable.

### PRIORITY INFORMATION

This application claims benefit of priority to U.S. Provisional Application Ser. No. 63/270,460, titled “Sidelink Positioning Architecture for Wireless Communications”, filed Oct. 21, 2021, which is hereby incorporated by reference in its entirety as though fully and completely set forth herein.

### FIELD OF THE INVENTION

The present application relates to wireless communications, including sidelink positioning in wireless communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (WCDMA, TDS-CDMA), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), BLUETOOTH™, etc. A current telecommunications standard moving beyond the current International Mobile Telecommunications-Advanced (IMT-Advanced) Standards is called 5th generation mobile networks or 5th generation wireless systems, referred to as 3GPP NR (otherwise known as 5G-NR or NR-5G for 5G New Radio, also simply referred to as NR). NR proposes a higher capacity for a higher density of mobile broadband users, also supporting device-to-device, ultra-reliable, and massive machine communications, as well as lower latency and lower battery consumption, than LTE standards.

One aspect of wireless communication systems, including NR cellular wireless communications, involves device-to-device communications, including sidelink communications, and device positioning during sidelink communications. Improvements in the field are desired.

### SUMMARY OF THE INVENTION

Embodiments are presented herein of, inter alia, methods and procedures for effective and efficient device positioning for communication devices, e.g., wireless communication devices, during wireless communications, for example during device-to-device or sidelink communications. Embodiments are further presented herein for wireless communication systems containing at least wireless communication devices or user equipment devices (UEs) and/or base stations and/or access points (APs) communicating with each other within the wireless communication systems.

In order to more accurately determine device positioning, the ProSe, V2X, and LCS architectures may be extended to accommodate sidelink device positioning. Accordingly, additional signaling may be added and/or existing signaling may be modified/enhanced to incorporate information and instructions for implementing sidelink positioning between multiple UEs.

For example, in some embodiments, a UE may be configured to may transmit, in a NAS registration request message to an AMF of a core network, an indication that the UE supports sidelink positioning. The UE may subsequently receive, from the AMF, an indication of authorization for the UE to use sidelink positioning. In some instances, the indication may be received responsive to a determination by the AMF that the UE is authorized to use sidelink positioning. In some instances, the indication of authorization for the UE to use sidelink positioning may be received in a NAS registration accept message

As another example, in some embodiments, a UE may be configured to transmit, in a ProSe sidelink discovery announcement message, an indication that the UE supports sidelink positioning. Then sidelink positioning may subsequently be used with the UE. For example, sidelink positioning may be used with the UE responsive to the ProSe sidelink discovery announcement message indicating that the UE supports sidelink positioning.

As a further example, in some embodiments, a UE may be configured to transmit, in a ProSe sidelink discovery solicitation message, an indication that the UE supports sidelink positioning. The UE may be configured to receive, from a neighboring UE, an indication that the other UE supports sidelink positioning. The indication that the neighboring UE supports sidelink positioning may be received in a ProSe discovery response message. Additionally, the UE may be configured to determine, responsive to the indications, that the UE and the neighboring UE are to use sidelink positioning between them.

As a yet further example, in some embodiments, a UE may be configured to transmit, over a V5 interface, a first indication that the UE supports sidelink positioning. The UE may be configured to receive, over the V5 interface from a neighboring UE, such as a neighboring UE 106, a second indication that neighboring UE supports sidelink positioning. Additionally, the UE may be configured to determine, responsive to the first indication and the second indication, that the UE and neighboring UE are to use sidelink positioning between them.

As yet another example, in some embodiments, the UE may be configured to transmit first information indicative of a sidelink positioning reference signal (PRS) capability of the UE. The UE may be configured to receive sidelink PRS configuration information for the UE. Further, the UE may be configured to transmit one or more sidelink PRSs according to the sidelink PRS configuration information.

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 illustrates an exemplary simplified block diagram illustrative of cellular communication circuitry, according to some embodiments.

FIGS. 6 and 7 illustrate exemplary flow diagrams for UE sidelink positioning based on an LCS architecture, according to some embodiments.

FIG. 8 illustrates an exemplary flow diagram for sidelink positioning authorization, according to some embodiments.

FIG. 9 illustrates an exemplary flow diagram for UE discovery for sidelink positioning using a discovery announcement message, according to some embodiments.

FIG. 10 illustrates an exemplary flow diagram for UE discovery for sidelink positioning using a discovery solicitation message, according to some embodiments.

FIG. 11 illustrates a block diagram of an example of a call flow for sidelink positioning using a V5 interface, according to some embodiments.

FIG. 12 illustrates a block diagram of an example of a call flow for sidelink positioning in wireless communications, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
5GMM: 5G Mobility Management
AF: Application Function
AMF: Access and Mobility Management Function
AMR: Adaptive Multi-Rate
AP: Access Point
APN: Access Point Name
APR: Applications Processor
BS: Base Station
BSSID: Basic Service Set Identifier
CBRS: Citizens Broadband Radio Service
CBSD: Citizens Broadband Radio Service Device
CCA: Clear Channel Assessment
CMR: Change Mode Request
CS: Circuit Switched
DL: Downlink (from BS to UE)
DMRS: Demodulation Reference Signal
DN: Data Network
DSDS: Dual SIM Dual Standby
DYN: Dynamic
EDCF: Enhanced Distributed Coordination Function
eSNPN: Equivalent Standalone Non-Public Network
ETSI: European Telecommunications Standards Institute
FDD: Frequency Division Duplexing
FT: Frame Type
GAA: General Authorized Access
GPRS: General Packet Radio Service
GSM: Global System for Mobile Communication
GTP: GPRS Tunneling Protocol
HPLMN: Home Public Land Mobile Network
IC: In Coverage
IMS: Internet Protocol Multimedia Subsystem
IOT: Internet of Things
IP: Internet Protocol
ITS: Intelligent Transportation Systems
LAN: Local Area Network
LBT: Listen Before Talk
LCS: Location Services
LMF: Location Management Function
LPP: LTE Positioning Protocol
LQM: Link Quality Metric
LTE: Long Term Evolution
MCC: Mobile Country Code
MNO: Mobile Network Operator
MO-LR: Mobile Originated Location Request
MT-LR: Mobile-Terminated Location Request
NAS: Non-Access Stratum
NF: Network Function
NG-RAN: Next Generation Radio Access Network
NID: Network Identifier
NMF: Network Identifier Management Function
NPN: Non-Public (cellular) Network
NRF: Network Repository Function
NSI: Network Slice Instance
NSSAI: Network Slice Selection Assistance Information
OOC: Out Of Coverage
PAL: Priority Access Licensee
PDCP: Packet Data Convergence Protocol
PDN: Packet Data Network
PDU: Protocol Data Unit
PGW: PDN Gateway
PLMN: Public Land Mobile Network
ProSe: Proximity Services
PRS: Positioning Reference Signal
PSCCH: Physical Sidelink Control Channel
PSFCH: Physical Sidelink Feedback Channel
PSSCH: Physical Sidelink Shared Channel
PSD: Power Spectral Density
PSS: Primary Synchronization Signal
PT: Payload Type
PTRS: Phase Tracking Reference Signal
QBSS: Quality of Service Enhanced Basic Service Set
QI: Quality Indicator
RA: Registration Accept
RAT: Radio Access Technology
RF: Radio Frequency
ROHC: Robust Header Compression
RR: Registration Request
RRC: Radio Resource Control
RSRP: Reference Signal Receive Power
RTP: Real-time Transport Protocol
RX: Reception/Receive
SAS: Spectrum Allocation Server
SD: Slice Descriptor
SI: System Information
SIB: System Information Block
SID: System Identification Number
SIM: Subscriber Identity Module
SGW: Serving Gateway
SMF: Session Management Function
SNPN: Standalone Non-Public Network
SSS: Secondary Synchronization Signal
SUPI: Subscription Permanent Identifier
TBS: Transport Block Size
TCP: Transmission Control Protocol
TDD: Time Division Duplexing
TDRA: Time Domain Resource Allocation
TPC: Transmit Power Control
TX: Transmission/Transmit
UAC: Unified Access Control
UDM: Unified Data Management
UDR: User Data Repository
UE: User Equipment
UI: User Input
UL: Uplink (from UE to BS)
UMTS: Universal Mobile Telecommunication System
UPF: User Plane Function
URM: Universal Resources Management
URSP: UE Route Selection Policy
USIM: User Subscriber Identity Module
Wi-Fi: Wireless Local Area Network (WLAN) RAT based on the Institute of Electrical and Electronics Engineers' (IEEE) 802.11 standards
WLAN: Wireless LAN

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g., Sony PlayStation™ Microsoft XBox™, etc.), portable gaming devices (e.g., Nintendo DS™, PlayStation Portable™, Gameboy Advance™, iPod™), laptops, wearable devices (e.g., smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example, a wireless device may be any type of wireless station of an 802.11 system, such as an access point (AP) or a client station (UE), or any type of wireless station of a cellular communication system communicating according to a cellular radio access technology (e.g., 5G NR, LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processor—refers to various elements (e.g., circuits) or combinations of elements that are capable of performing a function in a device, e.g., in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Station (STA)—The term “station” herein refers to any device that has the capability of communicating wirelessly, e.g., by using the 802.11 protocol. A station may be a laptop, a desktop PC, PDA, access point or Wi-Fi phone or any type of device similar to a UE. An STA may be fixed, mobile, portable or wearable. Generally, in wireless networking terminology, a station (STA) broadly encompasses any device with wireless communication capabilities, and the terms station (STA), wireless client (UE) and node (BS) are therefore often used interchangeably.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g., 10 ms). A radio frame in 3GPP LTE may be further divided into a specified number of (e.g., ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g., a time period of specific length) per 1 subcarrier (in reference to a frequency resource, e.g., a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.

Bandwidth Part (BWP)—A carrier bandwidth part (BWP) is a contiguous set of physical resource blocks selected from a contiguous subset of the common resource blocks for a given numerology on a given carrier. For downlink, a UE may be configured with up to a specified number of carrier BWPs (e.g., four BWPs, per some specifications), with one BWP per carrier active at a given time (per some specifications). For uplink, the UE may similarly be configured with up to several (e.g., four) carrier BWPs, with one BWP per carrier active at a given time (per some specifications). If a UE is configured with a supplementary uplink, then the UE may be additionally configured with up to the specified number (e.g., four) carrier BWPs in the supplementary uplink, with one carrier BWP active at a given time (per some specifications).

Multi-cell Arrangements—A Master node is defined as a node (radio access node) that provides control plane connection to the core network in case of multi radio dual connectivity (MR-DC). A master node may be a master eNB (3GPP LTE) or a master gNB (3GPP NR), for example. A secondary node is defined as a radio access node with no control plane connection to the core network, providing additional resources to the UE in case of MR-DC. A Master Cell group (MCG) is defined as a group of serving cells associated with the Master Node, including the primary cell (PCell) and optionally one or more secondary cells (SCell). A Secondary Cell group (SCG) is defined as a group of serving cells associated with the Secondary Node, including a special cell, namely a primary cell of the SCG (PSCell), and optionally including one or more SCells. A UE may typically apply radio link monitoring to the PCell. If the UE is configured with an SCG then the UE may also apply radio link monitoring to the PSCell. Radio link monitoring is generally applied to the active BWPs and the UE is not required to monitor inactive BWPs. The PCell is used to initiate initial access, and the UE may communicate with the PCell and the SCell via Carrier Aggregation (CA). Currently Amended capability means a UE may receive and/or transmit to and/or from multiple cells. The UE initially connects to the PCell, and one or more SCells may be configured for the UE once the UE is in a connected state.

Core Network (CN)—Core network is defined as a part of a 3GPP system which is independent of the connection technology (e.g., the Radio Access Technology, RAT) of the UEs. The UEs may connect to the core network via a radio access network, RAN, which may be RAT-specific.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

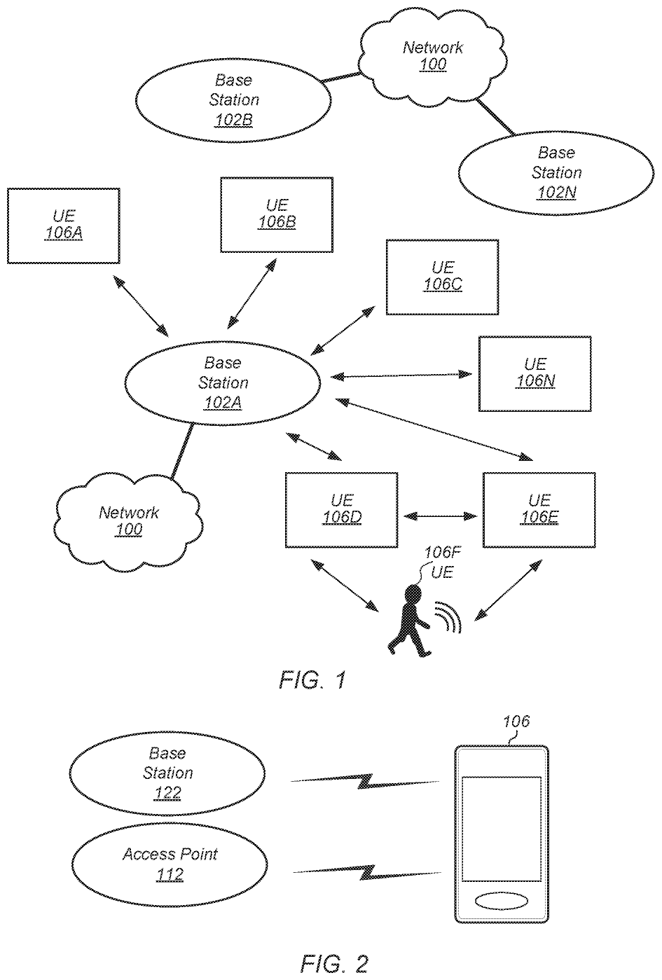

### FIGS. 1 and 2—Exemplary Communication Systems

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes base stations 102A through 102N, also collectively referred to as base station(s) 102 or base station 102. As shown in FIG. 1, base station 102A communicates over a transmission medium with one or more user devices 106A through 106N. Each of the user devices may be referred to herein as a “user equipment” (UE) or UE device. Thus, the user devices 106A through 106N are referred to as UEs or UE devices, and are also collectively referred to as UE(s) 106 or UE 106. Various ones of the UE devices may transmit reference signals, according to various embodiments disclosed herein.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, neutral host or various CBRS (Citizens Broadband Radio Service) deployments, among various possibilities). Thus, the base station 102A may facilitate communication between the user devices 106 and/or between the user devices 106 and the network 100. In particular, the cellular base station 102A may provide UEs 106 with various telecommunication capabilities, such as voice, short message service (SMS) and/or data services. The communication area (or coverage area) of the base station 106 may be referred to as a “cell.” It is noted that “cell” may also refer to a logical identity for a given wireless communication coverage area at a given frequency. In general, any independent cellular wireless coverage area may be referred to as a “cell”. In such cases a base station may be situated at particular confluences of three cells. The base station, in this uniform topology, may serve three 120-degree beam width areas referenced as cells. Also, in case of carrier aggregation, small cells, relays, etc. may each represent a cell. Thus, in carrier aggregation in particular, there may be primary cells and secondary cells which may service at least partially overlapping coverage areas but on different respective frequencies. For example, a base station may serve any number of cells, and cells served by a base station may or may not be collocated (e.g., remote radio heads). As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network, and may further also be considered at least a part of the UE communicating on the network or over the network.

The base station(s) 102 and the user devices 106 may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G-NR (NR, for short), 3GPP2 CDMA2000 (e.g., 1×RTT, 1×EV-DO, HRPD, eHRPD), Wi-Fi, WiMAX etc. Note that if the base station 102A is implemented in the context of LTE, it may alternately be referred to as an ‘eNodeB’ or eNB′. Similarly, if the base station 102A is implemented in the context of 5G NR, it may alternately be referred to as ‘gNodeB’ or ‘gNB’. In some embodiments, the base station 102 (e.g., an eNB in an LTE network or a gNB in an NR network) may communicate with at least one UE having the capability to transmit reference signals according to various embodiments disclosed herein. Depending on a given application or specific considerations, for convenience some of the various different RATs may be functionally grouped according to an overall defining characteristic. For example, all cellular RATs may be collectively considered as representative of a first (form/type of) RAT, while Wi-Fi communications may be considered as representative of a second RAT. In other cases, individual cellular RATs may be considered individually as different RATs. For example, when differentiating between cellular communications and Wi-Fi communications, “first RAT” may collectively refer to all cellular RATs under consideration, while “second RAT” may refer to Wi-Fi. Similarly, when applicable, different forms of Wi-Fi communications (e.g., over 2.4 GHz vs. over 5 GHz) may be considered as corresponding to different RATs. Furthermore, cellular communications performed according to a given RAT (e.g., LTE or NR) may be differentiated from each other on the basis of the frequency spectrum in which those communications are conducted. For example, LTE or NR communications may be performed over a primary licensed spectrum as well as over a secondary spectrum such as an unlicensed spectrum and/or spectrum that was assigned to private networks. Overall, the use of various terms and expressions will always be clearly indicated with respect to and within the context of the various applications/embodiments under consideration.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices 106 and/or between the user devices 106 and the network 100. In particular, the cellular base station 102A may provide UEs 106 with various telecommunication capabilities, such as voice, SMS and/or data services. UE 106 may be capable of communicating using multiple wireless communication standards. For example, a UE 106 might be configured to communicate using any or all of a 3GPP cellular communication standard (such as LTE or NR) or a 3GPP2 cellular communication standard (such as a cellular communication standard in the CDMA2000 family of cellular communication standards). Base station 102A and other similar base stations (such as base stations 102B . . . 102N) operating according to the same or a different cellular communication standard may thus be provided as one or more networks of cells, which may provide continuous or nearly continuous overlapping service to UE 106 and similar devices over a wide geographic area via one or more cellular communication standards.

Thus, while base station 102A may act as a “serving cell” for UEs 106A-106N as illustrated in FIG. 1, each one of UE(s) 106 may also be capable of receiving signals from (and may possibly be within communication range of) one or more other cells (possibly provided by base stations 102B-102N and/or any other base stations), which may be referred to as “neighboring cells”. Such cells may also be capable of facilitating communication in-between user devices 106 and/or between user devices 106 and the network 100. Such cells may include “macro” cells, “micro” cells, “pico” cells, and/or cells which provide any of various other granularities of service area size. For example, base stations 102A-102B illustrated in FIG. 1 may be macro cells, while base station 102N may be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs.

The UE 106 might also or alternatively be configured to communicate using WLAN, BLUETOOTH™, BLUETOOTH™ Low-Energy, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible. Furthermore, the UE 106 may also communicate with Network 100, through one or more base stations or through other devices, stations, or any appliances not explicitly shown but considered to be part of Network 100. UE 106 communicating with a network may therefore be interpreted as the UE(s) 106 communicating with one or more network nodes considered to be a part of the network and which may interact with the UE(s) 106 to conduct communications with the UE(s) 106 and in some cases affect at least some of the communication parameters and/or use of communication resources of the UE(s) 106.

As also illustrated in FIG. 1, at least some of the UEs, e.g., UEs 106D and 106E may represent vehicles communicating with each other and with base station 102, e.g., via cellular communications such as 3GPP LTE and/or 5G-NR communications, for example. In addition, UE 106F may represent a pedestrian who is communicating and/or interacting in a similar manner with the vehicles represented by UEs 106D and 106E. Various embodiments of vehicles communicating in a network exemplified in FIG. 1 are disclosed, for example, in the context of vehicle-to-everything (V2X) communications such as the communications specified by certain versions of the 3GPP standard, among others.

FIG. 2 illustrates an exemplary user equipment 106 (e.g., one of UEs 106A through 106N) in communication with the base station 122 and an access point 112, according to some embodiments. The UE 106 may be a device with both cellular communication capability and non-cellular communication capability (e.g., BLUETOOTH™, Wi-Fi, and so forth) such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, NR, WLAN, or GNSS. Other combinations of wireless communication standards are also possible.

The UE 106 may include one or more antennas for communicating using one or more wireless communication protocols according to one or more RAT standards, e.g., those previously mentioned above. In some embodiments, the UE 106 may share one or more parts of a receive chain and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As another alternative, the UE 106 may include one or more radios or radio circuitry which are shared between multiple wireless communication protocols, and one or more radios which are used exclusively by a single wireless communication protocol. For example, the UE 106 may include radio circuitries for communicating using either of LTE or CDMA2000 1×RTT or NR, and separate radios for communicating using each of Wi-Fi and BLUETOOTH™. Other configurations are also possible.

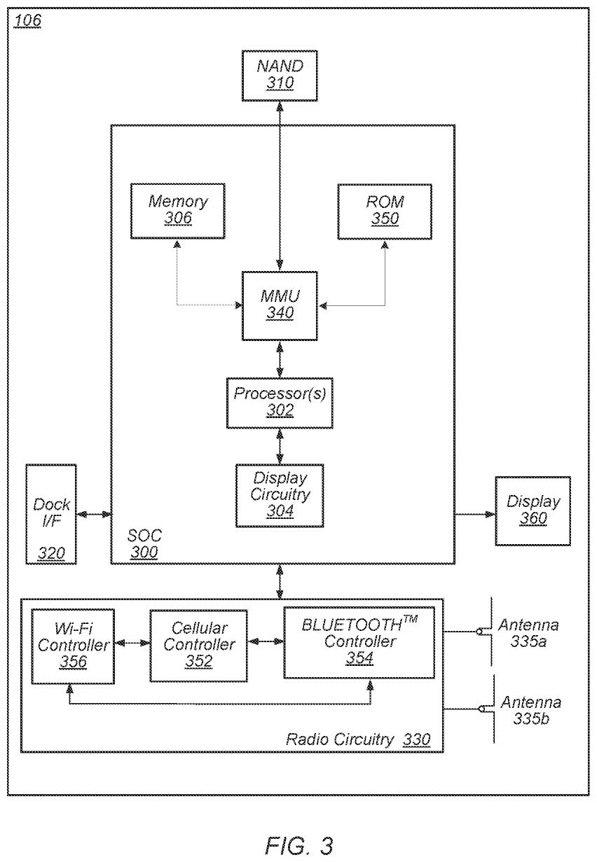

### FIG. 3—Block Diagram of an Exemplary UE

FIG. 3 illustrates a block diagram of an exemplary UE 106, according to some embodiments. As shown, the UE 106 may include a system on chip (SOC) 300, which may include various elements/components for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to the computer system), the display 360, and wireless communication circuitry (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna(s) 335. For example, the UE device 106 may use antenna(s) 335 to perform the wireless communication with the aid of radio circuitry 330. As noted above, the UE may be configured to communicate wirelessly using multiple wireless communication standards in some embodiments.

As further described herein, the UE 106 (and/or base station 102) may include hardware and software components for implementing methods for at least UE 106 to transmit reference signals according to various embodiments disclosed herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to implement communications by UE 106 to transmit reference signals according to various embodiments disclosed herein. Specifically, processor(s) 302 may be coupled to and/or may interoperate with other components as shown in FIG. 3 to facilitate UE 106 communicating in a manner that seeks to optimize RAT selection. Processor(s) 302 may also implement various other applications and/or end-user applications running on UE 106.

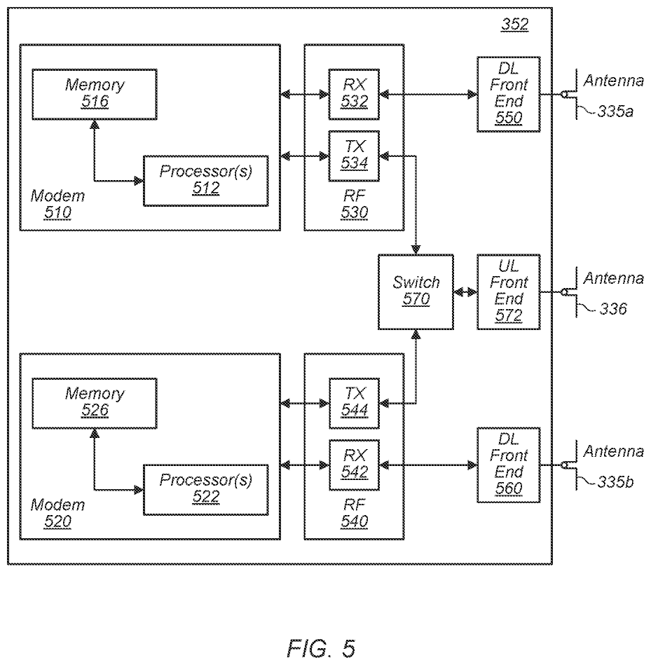

In some embodiments, radio circuitry 330 may include separate controllers dedicated to controlling communications for various respective RATs and/or RAT standards. For example, as shown in FIG. 3, radio circuitry 330 may include a Wi-Fi controller 356, a cellular controller (e.g., LTE and/or NR controller) 352, and BLUETOOTH controller 354, and according to at least some embodiments, one or more or all of these controllers may be implemented as respective integrated circuits (ICs or chips, for short) in communication with each other and with SOC 300 (e.g., with processor(s) 302). For example, Wi-Fi controller 356 may communicate with cellular controller 352 over a cell-ISM link or WCI interface, and/or BLUETOOTH™ controller 354 may communicate with cellular controller 352 over a cell-ISM link, etc. While three separate controllers are illustrated within radio circuitry 330, other embodiments may have fewer or more similar controllers for various different RATs and/or RAT standards that may be implemented in UE device 106. For example, at least one exemplary block diagram illustrative of some embodiments of cellular controller 352 is shown in FIG. 5 and will be further described below.

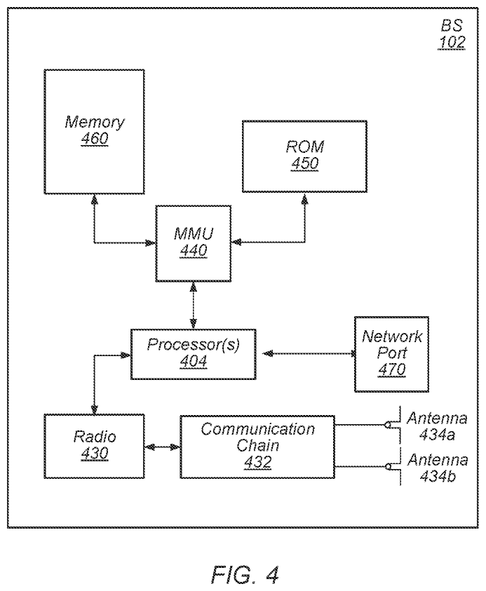

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434a, and possibly multiple antennas (e.g., illustrated by antennas 434a and 434b), for performing wireless communication with mobile devices and/or other devices. Antennas 434a and 434b are shown by way of example, and base station 102 may include fewer or more antennas. Overall, the one or more antennas, which may include antenna 434a and/or antenna 434b, are collectively referred to as antenna 434 or antenna(s) 434. Antenna(s) 434 may be configured to operate as a wireless transceiver and may be further configured to communicate with UE devices 106 via radio circuitry 430. The antenna(s) 434 communicates with the radio 430 via communication chain 432. Communication chain 432 may be a receive chain, a transmit chain or both. The radio circuitry 430 may be designed to communicate via various wireless telecommunication standards, including, but not limited to, LTE, LTE-A, 5G-NR (NR) WCDMA, CDMA2000, etc. The processor(s) 404 of the base station 102 may be configured to implement part or all of the methods described herein, e.g., by executing program instructions stored on a memory medium (e.g., a non-transitory computer-readable memory medium), for base station 102 to communicate with a UE device that transmits reference signals as disclosed herein. Alternatively, the processor(s) 404 may be configured as a programmable hardware element(s), such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard. Base station 102 may operate according to the various methods as disclosed herein for communicating with mobile devices that transmit reference signals according to various embodiments disclosed herein.

### FIG. 5—Exemplary Cellular Communication Circuitry

FIG. 5 illustrates an exemplary simplified block diagram illustrative of cellular controller 352, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 352 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 352 may couple (e.g., communicatively; directly or indirectly) to one or more antennas, such as antennas 335a-b and 336 as shown. In some embodiments, cellular communication circuitry 352 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 352 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 352 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 352 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more components. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 352 may include only one transmit/receive chain. For example, the cellular communication circuitry 352 may not include the modem 520, the RF front end 540, the DL front end 560, and/or the antenna 335b. As another example, the cellular communication circuitry 352 may not include the modem 510, the RF front end 530, the DL front end 550, and/or the antenna 335a. In some embodiments, the cellular communication circuitry 352 may also not include the switch 570, and the RF front end 530 or the RF front end 540 may be in communication, e.g., directly, with the UL front end 572.

### Device-to-Device and Sidelink Communications

Device-to-device (D2D) communication refers to user equipment devices (UEs) directly communicating with one other without transferring data through a base station (BS) or other higher-level network infrastructure. D2D communication plays a crucial role in enhancing the coverage and transmission capacity of cellular communications. One example of D2D communications was provided above with respect to FIG. 1, in which UEs 106D and 106E may represent vehicles communicating directly with each other. Various embodiments of vehicles communicating with each other as exemplified in FIG. 1 may be in the context of vehicle-to-everything (V2X) communications which cover D2D communications, such as the communications specified by certain versions of the 3GPP standard. D2D-enabled cellular networks may make provisions for D2D users to share spectrum resources in two different ways. In-band D2D communications may take place over the licensed spectrum while out-band D2D communication may take place over the unlicensed spectrum. In-band D2D may be further divided into two categories, an underlay category in which D2D users share the same frequency resources used by cellular users and an overlay category in which both network-bases and D2D communications use orthogonal spectrum resources. With the rising number of cellular users, it has become challenging to accommodate all users within the limited available spectrum and to provision wide bandwidths for high data rate applications such as online gaming, video sharing etc. One way of improving the energy efficiency of wireless networks includes the use of relay nodes or relay UEs. Instead of one long hop from one node to another, various UEs may be operated as strategically deployed/positioned relays to turn a single long hop into two or more shorter hops. Although the operation of relays is greatly affected by pathloss models and environmental conditions, it has proven effective in reducing pathloss and improving D2D communications.

In D2D communications, e.g., cellular wireless communications, sidelink communication (also referred to as communication over a PC5 link, where PC5 link refers to sidelink) represents the communication mechanism between devices that is not carried through a base station, e.g., it is not carried through an eNB/gNB. In other words, the devices communicate with each other without the communication requiring facilitation by a base station. It is in this sense that the devices may be said to be communicating with each other directly. Accommodation of such communication between devices (or between UEs/PUEs) includes a physical layer design featuring minimal design changes with respect to previous implementations.

### Sidelink Positioning

Device positioning, e.g., determining the position/geolocation of a mobile device, has become an integral part of wireless communications. Various protocols and services have been introduced to aid with device positioning. For example, the radio resource location services (LCS) protocol (RRLP) has been used in cellular networks to exchange messages between a mobile device and a Serving Mobile Location Center (SMLC) in order to provide geolocation information (the SMLC is a network element that typically resides in a base station controller and calculates a network-based location of mobile devices). Similarly, Proximity Services (ProSe) is a D2D technology that allows mobile devices to detect each other and to communicate directly. ProSe relies on the sidelink communications for direct connectivity between devices and offers several distinct benefits including better scalability, manageability, privacy, security and battery-efficiency.

Sidelink positioning has been in discussions for inclusion in the 3GPP standard and is likely to be incorporated into 3GPP Release 18 (Rel-18). Sidelink positioning functionality is likely to support ranging (e.g., distance measurements between mobile devices or UEs communicating via sidelink) and estimation of absolute coordinates (using sidelink signals from multiple UEs). While the topic has been widely discussed, system (e.g., architecture) aspects have not been detailed.

Embodiments described herein are directed to various aspects of a proposed sidelink positioning architecture (SPA) that includes, but is not limited to, an extension/enhancement of the current LCS architecture that incorporates sidelink positioning, an extension/enhancement of the ProSe Architecture that incorporates sidelink positioning, and/or an extension/enhancement of the V2X Architecture.

Sidelink positioning (e.g., as will be defined within the 3GPP standard) is expected to make provisions for sidelink positioning reference signals (sidelink PRSs) and corresponding sidelink PRS measurements. In order to provide adequate support for sidelink positioning, the following higher layer aspects of sidelink positioning may be considered:
Overall message call flow;
Authorization;
Discovery;
Capability negotiation;
Sidelink PRS transmission triggering; and/or
Measurement triggering.

### Extension of ProSe Architecture

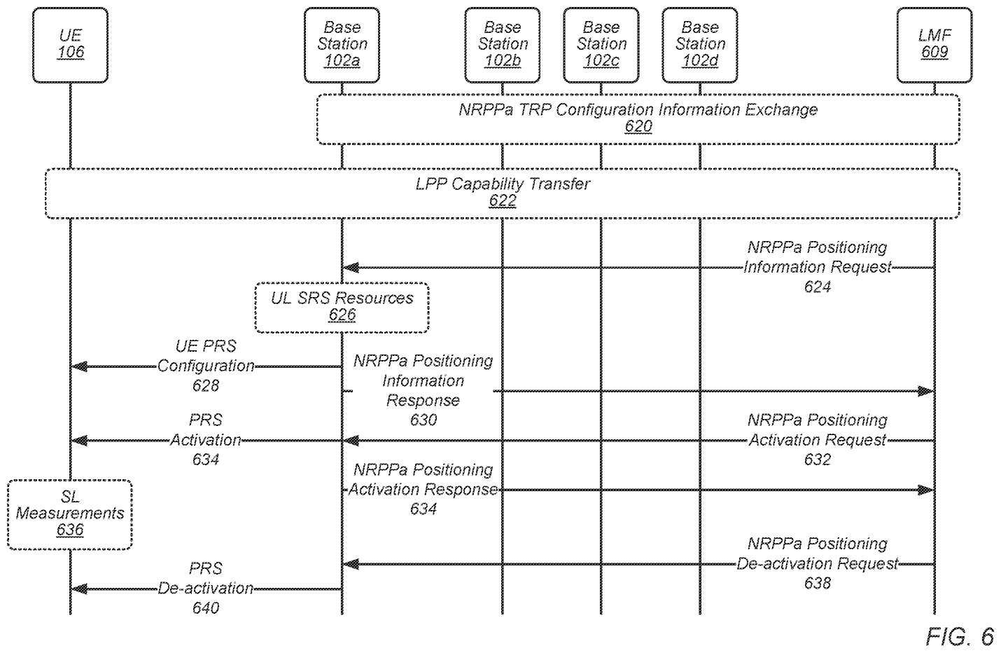

The 3GPP standard (e.g., TS 23.304; FIG. 4.2.1-2) provides an overview of the current ProSe architecture. As also detailed in the 3GPP standard (e.g., TS 23.304; FIG. 6.3.2.1-1 and FIG. 6.3.2.1-2, respectively), there are presently two signaling models, model A and model B, for ProSe discovery. According to model A, an announcing UE transmits an announcement message which may be monitored by one or more additional UEs for discovering the announcing UE. According to model B, a discovering UE may transmit a solicitation message, which may be detected by one or more discovered UEs, which may in turn transmit a response message to the discovering UE.

Various embodiments of an extension of the ProSe architecture for sidelink positioning may support UE-based positioning in both in-coverage and out-of-coverage modes. An authorization procedure to use sidelink positioning may be performed while in-coverage, with the authorization also valid for when the UE is subsequently out-of-coverage.

An exemplary call flow for sidelink positioning may be as follows, with proposed extensions to the ProSe architecture underlined below:
Authorization procedure (to use sidelink positioning):
   UE supporting sidelink positioning may indicate this capability in a non-access stratum (NAS) Registration Request message to the access and mobility management function (AMF) (e.g., in a “5GMM capability information element”, per 3GPP TS 24.501), with one of the (current) spare bits be designated for indicating “sidelink positioning” capability;
   If the UE is authorized (based on its subscription) to use sidelink positioning, the AMF may indicate this authorization to the UE, e.g., in a NAS Registration Accept message;
Discovery procedure (to discover candidate UEs for sidelink positioning):
   ProSe Discovery procedure may be used, enhanced with an indication for/of sidelink positioning; both Model A and Model B ProSe discovery options may be supported;
   Model A:
      The UE transmitting the ProSe PC5 discovery announcement message (per 3GPP TS 24.554) may indicate support for sidelink positioning in the message;
      A monitoring UE receiving the announcement message learns that it (the monitoring UE) may use sidelink positioning with the UE (transmitting the discovery announcement message);
   Model B:
      UE1 (discoverer) may transmit a ProSe PC5 discovery solicitation message indicating support for sidelink positioning in the message;
      If UE2 (discovered UE) supports sidelink positioning, it (discovered UE) may transmit a ProSe PC5 discovery response message indicating support for sidelink positioning;
      Both UE1 and UE2 thereby determine they can use sidelink positioning between them;
UE1 establishes PC5-RRC connection with UE2;
Capability information exchange:
   UE1 indicates its sidelink positioning capabilities and configuration (e.g., sidelink PRS bandwidth) in a UECapabilityEnquirySidelink information element (IE) sent to UE2;
   UE2 indicates its sidelink positioning capabilities and configuration (e.g., sidelink PRS bandwidth) in a UECapabilitylnformationSidelink IE sent to UE1;
Measurements:
   UE1 requests UE2 to transmit sidelink PRS using the RRCReconfigurationSidelink IE;
   UE1 performs sidelink PRS measurements (with one or more UEs) and calculates its relative location with respect to the one or more UEs.

The procedures defined above enable estimating the relative positioning (or ranging) between two or more UEs. In order to support absolute location (e.g., coordinates), ranging with a number of UEs (e.g., at least 3 UEs) with known coordinates may be used. At least two options of communicating the UE coordinates may be defined as follows:
Using PC5-RRC signaling and specific IEs, e.g., UECapabilityEnquirySidelink and
UECapabilitylnformationSidelink to communicate the coordinates; Using ProSe messages, e.g., ProSe Direct Link modification request/accept and ProSe Direct Link keepalive request/response IEs to communicate the coordinates.

### Extension of V2X Architecture

The 3GPP standard (e.g., TS 23.287; FIG. 4.2.1.1-1) provides an overview of the current V2X architecture. It should be noted that the V5 and V1 interfaces are not specified in the 3GPP standard (the V5 interface is defined by the European Telecommunications Standards Institute, ETSI, while the V1 interface is the reference point between the V2X application server in the UE and the V2X application server).

Various embodiments of an extension of the V2X architecture for sidelink positioning may support UE-based positioning in both in-coverage and out-of-coverage modes. An authorization procedure to use sidelink positioning may be performed while in-coverage, with the authorization also valid for when the UE is subsequently out-of-coverage.

An exemplary call flow for sidelink positioning may be as follows, with proposed extensions to the V2X architecture underlined below:
Authorization procedure (to use sidelink positioning):
   Option 1:
      UE supporting sidelink positioning indicates this capability in a NAS Registration Request message (e.g., per TS 24.501) to the AMF, e.g., in a “5GMM capability information element” (per TS 24.501), in which one of the (current) spare bits may be designated for indicating “sidelink positioning” capability;
      If the UE is authorized (based on its subscription) to use sidelink positioning, the AMF may indicate this to the UE in a NAS Registration Accept message;
   Option 2:
      Indicate the sidelink positioning capability by the V2X Application Server via V1 reference point (outside the scope of the 3GPP standard);
Discovery procedure (to discover candidate UEs for sidelink positioning—over V5 interface):
   V2X application protocol may be used over the V5 interface (e.g., ETSI Intelligent Transportation System, ITS, protocol) to transmit information indicating UE sidelink positioning capability;
   Option 1—Society of Automotive Engineers, SAE International, Basic Safety Message may be used;
   Option 2—ETSI ITS Cooperative Awareness Basic Service (ETSI EN 302 637-2) may be used.
   UE1 establishes PC5-RRC connection with UE2;
   Capability information exchange:
      UE1 indicates its sidelink positioning capabilities and configuration (e.g., sidelink PRS bandwidth) in a UECapabilityEnquirySidelink IE sent to UE2;
      UE2 indicates its sidelink positioning capabilities and configuration (e.g., sidelink PRS bandwidth) in a UECapabilityInformationSidelink IE sent to UE1;
   Measurements:
      UE1 requests UE2 to transmit sidelink PRS using the RRCReconfigurationSidelink IE;
      UE1 performs sidelink PRS measurements (with one or more UEs) and calculates its relative location with respect to the one or more UEs.

Since both SAE and ETSI ITS V2X application protocols already support transmission of absolute coordinates (e.g., referencePosition IE in ETSI ITS Cooperative Awareness Basic Service as disclosed in ETSI EN 302 637-2), both ranging and absolute location estimating may be supported.

### Extension of LCS Architecture

The 3GPP standard (e.g., TS 23.273; FIG. 4.2.2-1) provides an overview of the current LCS architecture. Furthermore, the 3GPP standard (e.g., TS 23.273; FIG. 6.1.2-1) describes a mobile-terminated location request (MT-LR) procedure, which includes a UE Positioning sub-procedure.

Various embodiments of an extension of the LCS architecture for sidelink positioning may introduce an updated UE positioning sub-procedure and may support UE-based positioning in in-coverage mode. However, in certain cases some out-of-coverage scenario(s) with UE-based positioning may be supported.

### First Approach

When both UEs participating in the sidelink positioning are in-coverage, the extension of the LCS architecture may incorporate UE-type Roadside Units (RSU) transmitting sidelink PRSs. An exemplary call flow for sidelink positioning is illustrated in FIG. 6 and may operate as follows, with proposed extensions to the LCS architecture underlined below. It should be noted that “NRPPa” refers to “NR Positioning Protocol A”, for example as disclosed in the 3GPP specification (e.g., TS 38.455).

At 620, a location management function, such as LMF 609, may perform NRPPa transmit receive point (TRP) capability transfer information exchange with one or more base stations and/or TRPs, such as base stations 102a-d. The NRPPa TRP capability transfer information exchange may carry and/or exchange sidelink positioning reference signal (PRS) capability information between the LMF and the TRPs. Further, at 622, the LMF 609 may perform an LTE positioning protocol (LPP) capability transfer with a UE, such as UE 106. The LPP capability transfer may carry and/or include the sidelink PRS capability information, e.g., the LMF 609 may exchange the sidelink PRS capability information with the UE 106. Further, the LMF 609 may send an NRPPa positioning information request 624 to the base station 102a. the NRPPa positioning information request 624 may include (and/or carry) a request for a sidelink PRS configuration, e.g., such as bandwidth). At 626, the base station 102a may determine resources for the UE 106, e.g., such as uplink sounding reference signal (SRS) resources and/or sidelink PRS resources. The base station 102a may transmit a UE PRS configuration 628 to the UE 106. The UE PRS configuration message 628 may be a radio resource control (RRC) sidelink PRS configuration message. The UE PRS configuration message 628 may include resources and/or an indication of resources for the sidelink PRS. Additionally, the base station 102a may send an NRPPa positioning information response 630 to the LMF 609. The NRPPa positioning information response 630 may include and/or carry/indicate information about the sidelink PRS configuration, e.g., such as bandwidth. Further, the LMF 609 may send an NRPPa positioning activation request 632 to the base station 102a. The NRPPa positioning activation request 632 may include and/or carry/indicate a request to start a sidelink PRS transmission. The base station 102a may then send the UE 106 a PRS activation message 634. The PRS activation message 634 may be a medium access control (MAC) control element (CE) that may indicate sidelink PRS transmission activation. At 636, the UE 106 may perform sidelink measurements. For example, the UE 106 may exchange (e.g., transmit and/or receive) sidelink PRSs with one or more neighboring UEs and/or other sidelink devices, e.g., such as RSUs. The UE 106 may report measurement results, e.g., based on the exchange of sidelink PRSs to the LMF 609. In some instances, the UE 106 may perform sidelink measurements in a manner similar to measurements performed in the context of the call flow described above for the extension of the ProSe architecture. Furthermore, if and/or when network-based UE-assisted positioning is supported, the UE(s)s may report sidelink PRS measurements to the LMF, e.g., using LPP. The LMF 609 may send an NRPPa positioning de-activation requestion 638 to the base station 102a. The NRPPa positioning de-activation requestion 638 may and/or may be used to deactivate sidelink PRS transmissions at the UE. In some instances, e.g., when the NRPPa positioning de-activation requestion 638 is not used to deactivate sidelink PRS transmissions at the UE, the base station 102a may send a PRS de-activation message 640 to the UE to indicate/instruct deactivation of sidelink PRS transmissions. In some instances, the PRS de-activation message 640 may be a MAC CE indicating deactivation of sidelink PRS transmissions.

In some instances, the exemplary call flow for sidelink positioning illustrated in FIG. 6 and may correspond to a call flow as defined in the LCS architecture with extensions to the LCS architecture underlined below:
Step 1 (corresponding to LPP capability transfer 622)—LTE Positioning Protocol (LPP) capability transfer—may carry sidelink PRS capability information;
Step 2 (corresponding to message 624)—NRPPa POSITIONING INFORMATION REQUEST—may carry request for sidelink PRS configuration (e.g., bandwidth);
Step 3a (corresponding to message 628)—RRC Sidelink PRS configuration message;
Step 4 (corresponding to message 630)—NRPPa POSITIONING INFORMATION RESPONSE—may carry information about Sidelink PRS configuration (e.g., bandwidth);
Step 5a (corresponding to message 632)—NRPPa POSITIONING ACTIVATION REQUEST—may carry request to start sidelink PRS transmission;
Step 5b (corresponding to message 634)—MAC CE Sidelink PRS transmission activation; Subsequent to Step 5c (e.g., (corresponding to SL measurements 636), the UEs may perform sidelink measurements (in a manner similar to measurements performed in the context of the call flow described above for the extension of the ProSe architecture); Furthermore, if network-based UE-assisted positioning is supported, the UEs may report sidelink PRS measurements to the Location Management Function (LMF) using LPP;
Step 9 (corresponding to message 638)—NRPPa POSITIONING DEACTIVATION—optional: may be used to deactivate UE sidelink PRS transmission, in which case 10 step below may be subsequently performed;
Step 10 (corresponding to message 640)—optional: MAC CE Sidelink PRS transmission deactivation (e.g., an instruction to deactivate transmission of sidelink PRSs) message, in case Step 9 is performed.

### Second Approach

In contrast to the first approach, according to a second approach, an LMF may communicate directly with a UE (e.g., via LPP) as opposed to communicating with the UE through a base station (e.g., gNB; via NRPPa and RRC/MAC CEs as detailed above for the first approach). Specifically, steps 2-5 described above (e.g., corresponding to signaling 624-634 from FIG. 6 may be implemented using LPP with the enhancement of the LPP RequestLocationInformation carrying sidelink PRS configuration and activation indication (information).

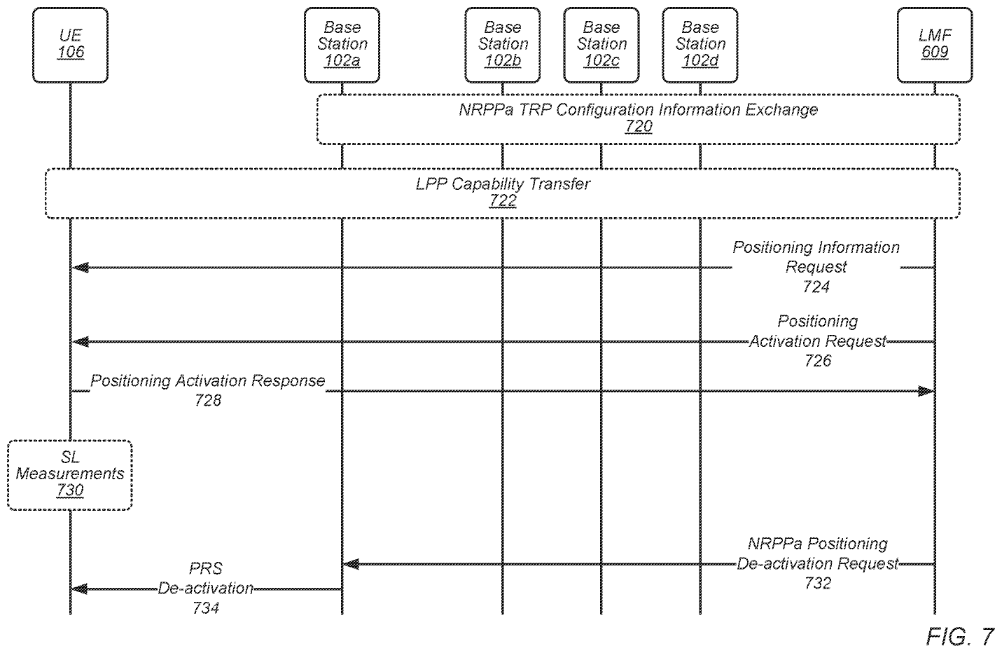

For example, FIG. 7 illustrates another exemplary flow diagram for UE sidelink positioning based on an LCS architecture, according to some embodiments. at 720, a location management function, such as LMF 609, may perform NRPPa transmit receive point (TRP) capability transfer information exchange with one or more base stations and/or TRPs, such as base stations 102a-d. The NRPPa TRP capability transfer information exchange may carry and/or exchange sidelink positioning reference signal (PRS) capability information between the LMF and the TRPs. Further, at 722, the LMF 609 may perform an LTE positioning protocol (LPP) capability transfer with a UE, such as UE 106. The LPP capability transfer may carry and/or include the sidelink PRS capability information, e.g., the LMF 609 may exchange the sidelink PRS capability information with the UE 106. Further, the LMF 609 may send a positioning information request 724 to the UE 106. The positioning information request 724 may include (and/or carry) a request for a sidelink PRS configuration, e.g., such as bandwidth), e.g., the position information request 724 may include and/or be an LPP RequestLocationInformation carrying sidelink PRS configuration and activation indication (information). The UE 106 may determine resources, e.g., such as uplink sounding reference signal (SRS) resources and/or sidelink PRS resources based on information in the positioning information request 724. Further, the LMF 609 may send positioning activation request 726 to the UE 106. The positioning activation request 726 may include and/or carry/indicate a request to start a sidelink PRS transmission. At 730, the UE 106 may perform sidelink measurements. For example, the UE 106 may exchange (e.g., transmit and/or receive) sidelink PRSs with one or more neighboring UEs and/or other sidelink devices, e.g., such as RSUs. The UE 106 may report measurement results, e.g., based on the exchange of sidelink PRSs to the LMF 609. In some instances, the UE 106 may perform sidelink measurements in a manner similar to measurements performed in the context of the call flow described above for the extension of the ProSe architecture. Furthermore, if and/or when network-based UE-assisted positioning is supported, the UE(s)s may report sidelink PRS measurements to the LMF, e.g., using LPP. The LMF 609 may send an NRPPa positioning de-activation requestion 732 to the base station 102a. The NRPPa positioning de-activation requestion 732 may and/or may be used to deactivate sidelink PRS transmissions at the UE. In some instances, e.g., when the NRPPa positioning de-activation requestion 732 is not used to deactivate sidelink PRS transmissions at the UE 106, the base station 102a may send a PRS de-activation message 734 to the UE to indicate/instruct deactivation of sidelink PRS transmissions. In some instances, the PRS de-activation message 734 may be a MAC CE indicating deactivation of sidelink PRS transmissions.

### Third Approach

The first approached detailed above is intended for in-coverage devices. For out-of-coverage devices, which may not be able to communicate with the LMF, a deferred MT-LR (and potentially MO-LR) LCS procedure may be used. When the UE is in-coverage, the LCS client may initiate a deferred LCS procedure, indicating an event when the location measurements need to be performed (e.g., when a first UE, UE1, is in proximity of a second UE, UE2). The third approach is intended for use with UE-based positioning, and the deferred MT-LR procedure may also be used in conjunction with the first and second approaches detailed above.

### Exemplary Call Flows

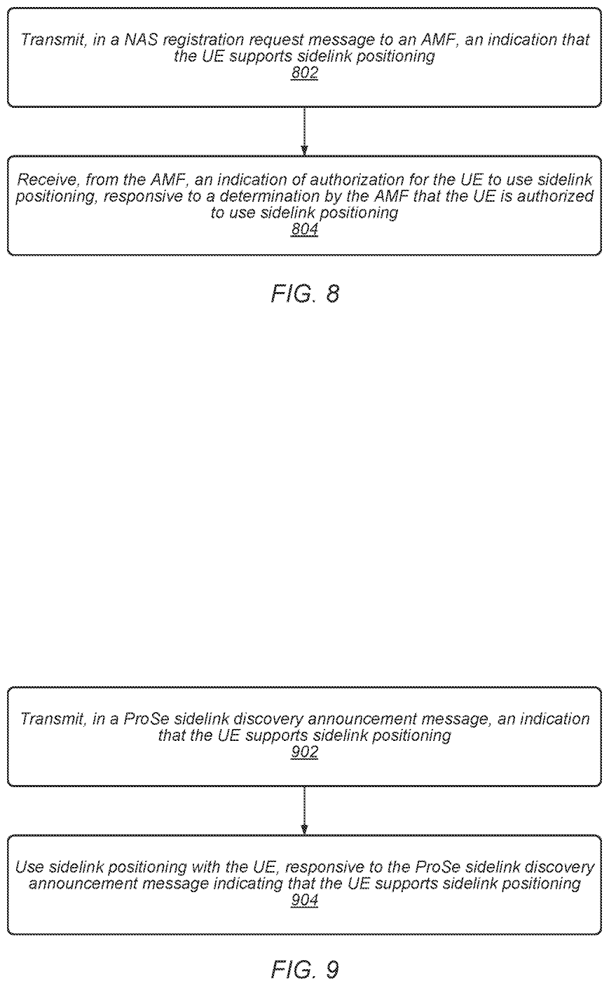

FIG. 8 illustrates a block diagram of an example of a call flow for sidelink positioning authorization, according to some embodiments. The call flow shown in FIG. 8 may be used in conjunction with any of the systems, methods, or devices shown in the Figures, among other devices. In various embodiments, some of the call flow elements shown may be performed concurrently, in a different order than shown, or may be omitted. Additional call flow may also be performed as desired. As shown, this call flow may operate as follows.

At 802, a UE, such as UE 106, may transmit, in a NAS registration request message to an access mobility and management function (AMF) of a core network, an indication that the UE supports sidelink positioning. The indication that the UE supports sidelink positioning may be included in a 5G Mobility Management (5GMM) capability information element (IE). In some instances, the 5GMM capability IE may include a bit designated for indicating sidelink positioning capability.

At 804, the UE may subsequently receive, from the AMF, an indication of authorization for the UE to use sidelink positioning. In some instances, the indication may be received responsive to a determination by the AMF that the UE is authorized to use sidelink positioning. In some instances, the indication of authorization for the UE to use sidelink positioning may be received in a NAS registration accept message

FIG. 9 illustrates a block diagram of an example of a call flow for sidelink positioning using a discovery announcement message, according to some embodiments. The call flow shown in FIG. 9 may be used in conjunction with any of the systems, methods, or devices shown in the Figures, among other devices. In various embodiments, some of the call flow elements shown may be performed concurrently, in a different order than shown, or may be omitted. Additional call flow may also be performed as desired. As shown, this call flow may operate as follows.

At 902, a UE, such as UE 106, may transmit, in a ProSe sidelink discovery announcement message, an indication that the UE supports sidelink positioning.

At 904, sidelink positioning may subsequently be used with the UE. For example, sidelink positioning may be used with the UE responsive to the ProSe sidelink discovery announcement message indicating that the UE supports sidelink positioning.

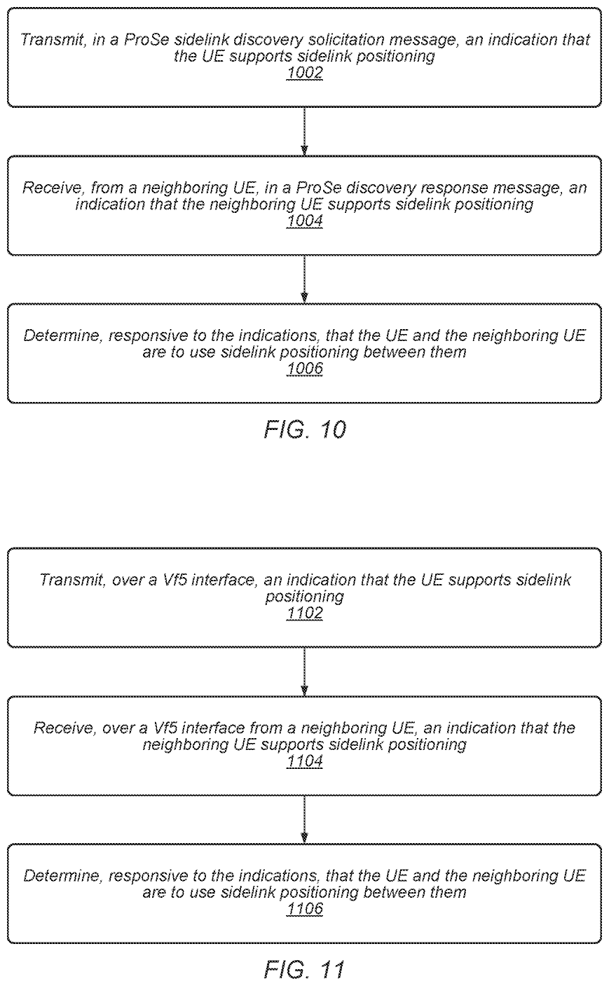

FIG. 10 illustrates a block diagram of an example of a call flow for sidelink positioning using a discovery solicitation message, according to some embodiments. The call flow shown in FIG. 10 may be used in conjunction with any of the systems, methods, or devices shown in the Figures, among other devices. In various embodiments, some of the call flow elements shown may be performed concurrently, in a different order than shown, or may be omitted. Additional call flow may also be performed as desired. As shown, this call flow may operate as follows.

At 1002, a UE, such as UE 106, may transmit, in a ProSe sidelink discovery solicitation message, an indication that the UE supports sidelink positioning.

At 1004, the UE may receive, from a neighboring UE, such as neighboring UE 106, in a ProSe discovery response message, an indication that the other UE supports sidelink positioning. The indication that the neighboring UE supports sidelink positioning may be received in a ProSe discovery response message.

At 1006, the UE and the neighboring UE may determine, responsive to the indications, that the UE and the neighboring UE are to use sidelink positioning between them.

In some instances, the UE may establish a sidelink radio resource control (RRC) connection with the neighboring UE, e.g., in response to the determination that the UE and the neighboring UE are to use sidelink positioning between them. In some instances, the UE may transmit, to the neighboring UE, first information about sidelink positioning configuration and capabilities of the UE and receive, from the neighboring UE, second information about sidelink positioning configuration and capabilities of the neighboring UE. The first information may be included in a UECapabilityEnquirySidelink information element (IE). The second information may be included in a UECapabilityInformationSidelink IE. In some instances, the UE may request that the neighboring UE transmit a sidelink positioning reference signal (PRS). Additionally, the UE may perform sidelink PRS measurements based, at least in part, on the transmitted PRS and calculate a relative position of the UE with respect to at least the neighboring UE. The relative position may be based, at least in part, on the sidelink PRS measurements. In some instances, the UE may communicate coordinates corresponding to an absolute position of the UE via one or more of sidelink radio resource control signaling or a ProSe message. In some instances, the coordinates may be included in one of a CapabilityEnquirySidelink information element (IE), a UECapabilityInformationSidelink IE, ProSe Direct Link modification request IE, a ProSe Direct Link modification accept IE, a ProSe Direct Link keepalive request IE, and/or a ProSe Direct Link keepalive response IE.

FIG. 11 illustrates a block diagram of an example of a call flow for sidelink positioning using a V5 interface, according to some embodiments. The call flow shown in FIG. 11 may be used in conjunction with any of the systems, methods, or devices shown in the Figures, among other devices. In various embodiments, some of the call flow elements shown may be performed concurrently, in a different order than shown, or may be omitted. Additional call flow may also be performed as desired. As shown, this call flow may operate as follows.

At 1102, a UE, such as UE 106, may transmit, over a V5 interface, a first indication that the UE supports sidelink positioning. In some instances, the first indication may be transmitted in and/or via a Society of Automotive Engineers (SAE) basic safety message. In some instances, the first indication may be transmitted in and/or via a European Telecommunications Standards Institute Intelligent Transport Systems Cooperative Awareness Basic Service message.

At 1104, the UE may receive, over the V5 interface from a neighboring UE, such as a neighboring UE 106, a second indication that neighboring UE supports sidelink positioning. In some instances, the second indication may be received in and/or via an SAE basic safety message. In some instances, the second indication may be received in and/or via a European Telecommunications Standards Institute Intelligent Transport Systems Cooperative Awareness Basic Service message.

At 1106, the UE may determine, responsive to the first indication and the second indication, that the UE and neighboring UE are to use sidelink positioning between them.

In some instances, the UE may establish a sidelink radio resource control (RRC) connection with the neighboring UE, e.g., in response to the determination that the UE and the neighboring UE are to use sidelink positioning between them.

In some instances, the UE may transmit, to the neighboring UE, first information about sidelink positioning configuration and capabilities of the UE. Additionally, the UE may receive, from the neighboring UE, second information about sidelink positioning configuration and capabilities of the neighboring UE. Further, the UE may request that the neighboring UE transmit a sidelink positioning reference signal (PRS) using an RRC reconfiguration sidelink information element. Additionally, the UE may perform sidelink PRS measurements based at least in part on the transmitted PRS and calculate a relative position of the UE with respect to at least the neighboring UE, e.g., based at least in part on the sidelink PRS measurements.

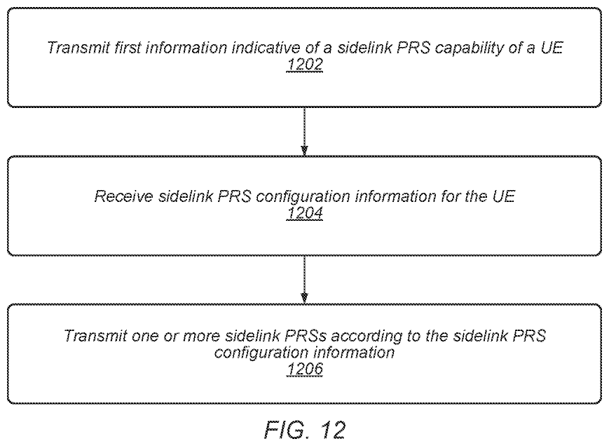

FIG. 12 illustrates a block diagram of an example of a call flow for sidelink positioning in wireless communications, according to some embodiments. The call flow shown in FIG. 12 may be used in conjunction with any of the systems, methods, or devices shown in the Figures, among other devices. In various embodiments, some of the call flow elements shown may be performed concurrently, in a different order than shown, or may be omitted. Additional call flow may also be performed as desired. As shown, this call flow may operate as follows.

At 1202, a UE, such as UE 106, may transmit first information indicative of a sidelink positioning reference signal (PRS) capability of the UE. In some instances, the UE may transmit the first information in a Long Term Evolution (LTE) positioning protocol (LPP) communication,

At 1204, the UE may receive sidelink PRS configuration information for the UE. The sidelink PRS configuration information may be received responsive to the UE transmitting the first information. The sidelink PRS configuration information may be receive in at least one of a radio resource control (RRC) sidelink PRS configuration message and/or an LPP communication.

At 1206, the UE may transmit one or more sidelink PRSs according to the sidelink PRS configuration information.

In some instances, the UE may receive a sidelink PRS transmission activation via at least one of a media access control (MAC) control element (CE) and/or an LPP communication. Further, the UE may transmit the one or more sidelink PRSs responsive, at least in part, to receiving the sidelink PRS transmission activation. In some instances, the sidelink PRS transmission activation may be received in the MAC CE based, at least in part, on information about sidelink PRS configuration of the UE carried in a New Radio Positioning Protocol A (NRPPa) positioning information response message. In such instances, the UE may receive the sidelink PRS transmission activation in the MAC CE responsive, at least, in part to a NRPPa positioning activation request carrying a request to start sidelink PRS transmission.

In some instances, the UE may receive the sidelink PRS configuration information in an RRC sidelink PRS configuration message responsive, at least in part, to an NRPPa information request carrying a request for sidelink PRS configuration.

In some instances, the UE may perform sidelink PRS measurements of sidelink PRSs transmitted by other UEs (e.g., by neighboring UEs). In such instances, the UE may report, using and/or via LPP, the sidelink PRS measurements to a location management function (LMF).

In some instances, the UE may receive, in a MAC CE, instruction to deactivate sidelink PRS transmissions. In such instances, the UE may stop transmission of the one or more PRSs responsive, at least in part, to receiving the instruction.

In some instances, the UE may transmit, in a network access stratum (NAS) registration request message to an access mobility and management function (AMF) of a core network, an indication that the UE supports sidelink positioning. The indication that the UE supports sidelink positioning may be included in a 5G Mobility Management (5GMM) capability information element (IE). In some instances, the 5GMM capability IE may include a bit designated for indicating sidelink positioning capability. Additionally, the UE may subsequently receive, from the AMF, an indication of authorization for the UE to use sidelink positioning. In some instances, the indication may be received responsive to a determination by the AMF that the UE is authorized to use sidelink positioning. In some instances, the indication of authorization for the UE to use sidelink positioning may be received in a NAS registration accept message.

In some instances, the UE may transmit, in a ProSe sidelink discovery announcement message, an indication that the UE supports sidelink positioning. Further, sidelink positioning may subsequently be used with the UE. For example, sidelink positioning may be used with the UE responsive to the ProSe sidelink discovery announcement message indicating that the UE supports sidelink positioning.

In some instances, the UE may transmit, in a ProSe sidelink discovery solicitation message, an indication that the UE supports sidelink positioning. Further, the UE may receive, from a neighboring UE, such as neighboring UE 106, in a ProSe discovery response message, an indication that the other UE supports sidelink positioning. The indication that the neighboring UE supports sidelink positioning may be received in a ProSe discovery response message. Additionally, the UE and the neighboring UE may determine, responsive to the indications, that the UE and the neighboring UE are to use sidelink positioning between them. In some instances, the UE may establish a sidelink radio resource control (RRC) connection with the neighboring UE, e.g., in response to the determination that the UE and the neighboring UE are to use sidelink positioning between them. In some instances, the UE may transmit, to the neighboring UE, first information about sidelink positioning configuration and capabilities of the UE and receive, from the neighboring UE, second information about sidelink positioning configuration and capabilities of the neighboring UE. The first information may be included in a UECapabilityEnquirySidelink information element (IE). The second information may be included in a UECapabilityInformationSidelink IE. In some instances, the UE may request that the neighboring UE transmit a sidelink positioning reference signal (PRS). Additionally, the UE may perform sidelink PRS measurements based, at least in part, on the transmitted PRS and calculate a relative position of the UE with respect to at least the neighboring UE. The relative position may be based, at least in part, on the sidelink PRS measurements. In some instances, the UE may communicate coordinates corresponding to an absolute position of the UE via one or more of sidelink radio resource control signaling or a ProSe message. In some instances, the coordinates may be included in one of a CapabilityEnquirySidelink information element (IE), a UECapabilityInformationSidelink IE, ProSe Direct Link modification request IE, a ProSe Direct Link modification accept IE, a ProSe Direct Link keepalive request IE, and/or a ProSe Direct Link keepalive response IE.

In some instances, the UE may transmit, over a V5 interface, a first indication that the UE supports sidelink positioning. In some instances, the first indication may be transmitted in and/or via a Society of Automotive Engineers (SAE) basic safety message. In some instances, the first indication may be transmitted in and/or via a European Telecommunications Standards Institute Intelligent Transport Systems Cooperative Awareness Basic Service message. The UE may receive, over the V5 interface from a neighboring UE, such as a neighboring UE 106, a second indication that neighboring UE supports sidelink positioning. In some instances, the second indication may be received in and/or via an SAE basic safety message. In some instances, the second indication may be received in and/or via a European Telecommunications Standards Institute Intelligent Transport Systems Cooperative Awareness Basic Service message. Additionally, UE may determine, responsive to the first indication and the second indication, that the UE and neighboring UE are to use sidelink positioning between them. In some instances, the UE may establish a sidelink radio resource control (RRC) connection with the neighboring UE, e.g., in response to the determination that the UE and the neighboring UE are to use sidelink positioning between them. In some instances, the UE may transmit, to the neighboring UE, first information about sidelink positioning configuration and capabilities of the UE. Additionally, the UE may receive, from the neighboring UE, second information about sidelink positioning configuration and capabilities of the neighboring UE. Further, the UE may request that the neighboring UE transmit a sidelink positioning reference signal (PRS) using an RRC reconfiguration sidelink information element. Additionally, the UE may perform sidelink PRS measurements based at least in part on the transmitted PRS and calculate a relative position of the UE with respect to at least the neighboring UE, e.g., based at least in part on the sidelink PRS measurements.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A user equipment device (UE), comprising:
at least one antenna;
at least one radio, wherein the at least one radio is configured to perform cellular communication using at least one radio access technology (RAT); and
one or more processors coupled to the at least one radio, wherein the one or more processors and the at least one radio are configured to perform communications; and
wherein the one or more processors are configured to cause the UE to:
transmit first information indicative of a sidelink positioning reference signal (PRS) capability of the UE;
receive sidelink PRS configuration information for the UE, wherein the sidelink PRS configuration information for the UE is received responsive to transmission of the first information; and
transmit one or more sidelink PRSs according to the sidelink PRS configuration information.

2. The UE of claim 1,
wherein the sidelink PRS configuration information for the UE is received via at least one of:
a radio resource control (RRC) sidelink PRS configuration message; or
a Long Term Evolution (LTE) positioning protocol (LPP) communication.

3. The UE of claim 1,
wherein the one or more processors are further configured to cause the UE to:
receive a sidelink PRS transmission activation, wherein the one or more sidelink PRSs are transmitted responsive, at least in part, to receipt of the sidelink PRS transmission activation.

4. The UE of claim 3,
wherein the sidelink PRS transmission activation is received via at least one of:
a media access control (MAC) control element (CE); or
a Long Term Evolution (LTE) positioning protocol (LPP) communication.

5. The UE of claim 3,
wherein the sidelink PRS transmission activation is received in a medium access control (MAC) control element (CE) based, at least in part, on information about the sidelink PRS configuration of the UE carried in a New Radio Positioning Protocol A (NRPPa) positioning information response message.

6. The UE of claim 5,
wherein the one or more processors are further configured to cause the UE to:
receive the sidelink PRS transmission activation in the MAC CE responsive, at least in part, to an NRPPa positioning activation request carrying a request to start sidelink PRS transmission.

7. The UE of claim 1,
wherein the sidelink PRS configuration information for the UE is received in a radio resource control (RRC) sidelink PRS configuration message responsive, at least in part, to a New Radio Positioning Protocol A (NRPPa) information request carrying a request for sidelink PRS configuration.

8. The UE of claim 1,
wherein the one or more processors are further configured to:
perform sidelink PRS measurements of sidelink PRSs transmitted by other UEs; and
report, using Long Term Evolution (LTE) positioning protocol (LPP) based communication, the sidelink PRS measurements to a location management function (LMF).

9. The UE of claim 1,
wherein the one or more processors are further configured to cause the UE to:
receive, in a media access control (MAC) control element (CE), instruction to deactivate sidelink PRS transmissions; and
discontinue transmission of the one or more PRSs responsive, at least in part, to receiving the instruction.

10. The UE of claim 1,
wherein the first information is transmitted in a Long Term Evolution (LTE) positioning protocol (LPP) communication.

11. An apparatus, comprising:
a memory; and
at least one processor in communication with the memory and configured to:
generate instructions to transmit first information indicative of a sidelink positioning reference signal (PRS) capability; and
receive, sidelink PRS configuration information associated with the apparatus responsive to transmission of the first information via at least one of:
a radio resource control (RRC) sidelink PRS configuration message; or
a Long Term Evolution (LTE) positioning protocol (LPP) communication; and
generate instructions to transmit one or more sidelink PRSs according to the sidelink PRS configuration information.

12. The apparatus of claim 11,
wherein the at least one processor is further configured to:
generate instructions to transmit, in a non-access stratum (NAS) registration request message to an access and mobility management function (AMF), an indication of support of sidelink positioning; and
receive, from the AMF, an indication of authorization to use sidelink positioning based on a determination usage of sidelink positioning is authorized, wherein the indication is received via NAS registration accept message.

13. The apparatus of claim 12,
wherein the indication of support of sidelink positioning is included in a 5G Mobility Management (5GMM) capability information element (IE), and wherein the 5GMM capability IE includes a bit designated for indicating sidelink positioning capability.

14. The apparatus of claim 11
wherein the at least one processor is further configured to:
generate instructions to transmit, in a Proximity Services (ProSe) sidelink discovery announcement message, an indication of support of sidelink positioning.

15. A method for sidelink positioning in wireless communications, comprising:
a user equipment device (UE),
transmitting first information indicative of a sidelink positioning reference signal (PRS) capability of the UE;
receiving sidelink PRS configuration information for the UE, wherein the sidelink PRS configuration information for the UE is received responsive to transmission of the first information; and
transmitting one or more sidelink PRSs according to the sidelink PRS configuration information.

16. The method of claim 15, further comprising:
the UE,
transmitting, in a Proximity Services (ProSe) sidelink discovery solicitation message, a first indication that the UE supports sidelink positioning;
receiving, in response from a neighboring UE, a second indication that the neighboring UE supports sidelink positioning via a ProSe discovery response message;
determining, responsive to the first indication and the second indication, to use sidelink positioning with the neighboring UE; and
exchanging, with the neighboring UE sidelink positioning configuration and capabilities via UECapabilityEnquirySidelink information elements (IEs).

17. The method of claim 16, further comprising:
the UE,
requesting the neighboring UE to transmit a sidelink positioning reference signal (PRS);
performing sidelink PRS measurements based at least in part on the transmitted PRS;
calculating a relative position of the UE with respect to at least the second UE, based at least in part on the sidelink PRS measurements; and
communicating coordinates corresponding to an absolute position of the UE via one or more of sidelink radio resource control signaling or a ProSe message, wherein the coordinates are included in at least one of:
a CapabilityEnquirySidelink information element (IE);
a UECapabilitylnformationSidelink IE;
a ProSe Direct Link modification request IE;
a ProSe Direct Link modification accept IE;
a ProSe Direct Link keepalive request IE; or
a ProSe Direct Link keepalive response IE.

18. The method of claim 15, further comprising:
the UE,
transmitting, over a V5 interface, a first indication of support of sidelink positioning via at least one of a Society of Automotive Engineers (SAE) basic safety message or a European Telecommunications Standards Institute Intelligent Transport Systems Cooperative Awareness Basic Service message;
receiving, over the V5 interface from a neighboring UE, a second indication that the neighboring UE supports sidelink positioning via at least one of an SAE basic safety message or a European Telecommunications Standards Institute Intelligent Transport Systems Cooperative Awareness Basic Service message;
determining, responsive to the first indication and the second indication, to use sidelink positioning with the neighboring UE; and
establishing a sidelink radio resource control (RRC) connection with the neighboring UE in response to the determination to use sidelink positioning with the neighboring UE.

19. The method of claim 18, further comprising:
the UE,
exchanging, with the neighboring UE sidelink positioning configuration and capabilities.

20. The method of claim 19, further comprising:
the UE,
requesting the neighboring UE to transmit a sidelink PRS using a radio resource control (RRC) reconfiguration sidelink information element;
performing sidelink PRS measurements based at least in part on the transmitted PRS; and
calculating a relative position of the UE with respect to at least the neighboring UE based, at least in part, on the sidelink PRS measurements.
